(19) United States
(12) Patent Application Publication
(10) Pub. No.: US 2014/0207634 A1
(43) Pub. Date: Jul. 24, 2014

(54) REFUND PURCHASE SYSTEM

(71) Applicant: Kevin Edmonds, Bradenton, FL (US)

(72) Inventor: Kevin Edmonds, Bradenton, FL (US)

(21) Appl. No.: 14/160,541

(22) Filed: Jan. 21, 2014

Related U.S. Application Data
(60) Provisional application No. 61/754,552, filed on Jan. 19, 2013.

(51) Int. Cl. G06Q 40/02; G06Q 40/00

(52) U.S. Cl. CPC G06Q 40/025; G06Q 40/10
USPC 705/31

(57) ABSTRACT

A system provides a software program that receives tax return information with an anticipated tax refund and taxpayer demographic information and automatically generates optional sell offers with corresponding discounted purchase prices. The sell offers and purchase prices are calculated for a portion of the refund at different levels (high, medium, low), and the system generates the documents that the taxpayer electronically signs to authenticate the offers. The system has a server which evaluates the offers for purchase based on several risk factors and either can select any of the offer levels that satisfy the purchaser's risk requirements. If none of the offer levels satisfy the risk requirements, the server reports back that the offers are rejected. For a selected offer, the system authorizes a payment of the discounted purchase price to the taxpayer when the taxing authority approves the return, before the taxing authority processes the refund for payment.

### CROSS-REFERENCE TO RELATED APPLICATIONS

This application claims priority from U.S. Provisional Patent Application No. 61/754,552 filed on Jan. 19, 2013 which is hereby incorporated by reference.

### STATEMENT REGARDING FEDERALLY SPONSORED RESEARCH

Not Applicable.

### APPENDIX

Not Applicable.

### BACKGROUND OF THE INVENTION

1. Field of the Invention

The present invention relates to paying taxpayers in advance for the right to receive at least a portion of their respective expected tax refunds, and more particularly to systems and methods that give taxpayers a market in which to offer one or more buyers the opportunity to purchase at least a portion of their respective expected tax refunds for purchase.

2. Related Art

For decades, refund anticipation loans (RAL) have been extremely popular because they provide a relatively large amount of cash to taxpayers very quickly after their respective tax returns are submitted to the Internal Revenue Service (IRS), many times within hours or one (1) or two (2) business days. Without the RAL vehicle, taxpayers would have to wait fourteen (14) days or even longer for the IRS to process and fund their refund. However, there has been growing opposition to RAL vehicle, and governmental bodies, including the Federal Deposit Insurance Corporation (FDIC) and the Office of the Comptroller of the Currency (OCC), are prohibiting banks from offering the RAL vehicle in 2013 and beyond. Accordingly, there is a need for a vehicle which can allow taxpayers to receive at least a portion of expected their tax refund quickly but which is not a recourse-style vehicle like the RAL vehicle and preferably is not a credit model as has been used with other vehicles to commoditize payments made by the government to individuals.

In addition to RAL systems, there are a number of systems which have developed over the years to provide lending vehicles, credit vehicles and other payment vehicles to annuity holders and other participants of government-sponsored financial distribution programs (entitlement programs) as well as individuals in corporate-sponsored programs. There are also systems that are designed for various purchasing vehicles in which a buyer makes an offer to buy a right to a future payment. However, in currently known systems, the purchaser, lender or issuer of credit tells the holder of the asset the discounted present value that they are willing to provide at the current time to buy certain rights to the asset. For example, with RAL systems, the RAL lender evaluates the return and then provides the taxpayer with an amount that they are willing to lend to the taxpayer in exchange for a portion of the tax refund amount or for the entire tax refund amount. There are other examples with an auction or businesses may offer a credit for purchasing their products or services in exchange for rights in the future payment. It would be beneficial to have a system in which potential sellers can create a sell offer of a portion of their refund or other future payment assets to one or more potential purchasers. It would be particularly beneficial for the system to provide taxpayers and tax preparers with an alternative system that is different from the loan-based RAL vehicle as well as other types of recourse-based models or credit-based models, including third party pre-payment loan vehicles and even some structured settlements.

### SUMMARY OF THE INVENTION

The system according to the present invention receives a set of inputs from the taxpayer and tax preparer. In the preferred embodiment, with basic initial information received from the taxpayer and possibly with additional information from the tax preparer, the present invention offers a nonrecourse and noncredit option for selling at least a portion of an anticipated tax refund. The preferred embodiment has a computerized system that can receive taxpayer demographic information, tax return information and any other information from the software vendor that the tax preparer may have used. Based on the information that is received by the system, the evaluations, determinations and calculations of the system's inventive system and methods propose three optional levels for the taxpayer to consider in an offer to sell a portion of the anticipated tax refund. The taxpayer chooses whether or not they want to select and present a sell offer to one or more potential buyers to purchase the right to the portion of their anticipated refund for a discounted purchase price.

The documents for the taxpayer to formally make the offer as the potential seller and to authorize the potential buyer to obtain debt information are automatically generated by the system for the particular deal and are electronically signed by the taxpayer. For the preferred embodiment in which a taxpayer's right to at least a portion of a tax refund is being purchased, when the taxing agency, such as the IRS, accepts the return and the risk associated with the offer is within the risk tolerances, the system authorizes the purchase price to be provided to the taxpayer. Requiring no additional effort on the taxpayer's part, the system coordinates a workflow with the settlement bank or other refund partner to create an account in which the actual refund from the taxing agency will be deposited so that the fees can be disbursed to the proper parties and the remaining portion of the refund can be provided to the taxpayer.

Further areas of applicability of the present invention will become apparent from the detailed description provided hereinafter in which it will be appreciated that certain aspects of the present invention are applicable to tax returns in general as well as a wide variety of financial transactions between parties. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings. The drawings constitute a part of this specification and include exemplary embodiments of the invention, which may be embodied in various forms. It is to be understood that in some instances, various aspects of the invention may be shown exaggerated or enlarged to facilitate an understanding of the invention; therefore the drawings are not necessarily to scale. In addition, in the embodiments depicted herein, like reference numerals in the various drawings refer to identical or near identical structural elements.

FIGS. 1A and 1B are system diagrams of the present invention.

FIG. 2 is a flowchart of the operations of the system.

FIG. 3 is a flowchart of the steps performed by the system.

FIGS. 4A-4E are screenshots of steps performed by the system.

### DETAILED DESCRIPTION OF THE PREFERRED EMBODIMENTS

The following description of the preferred embodiment(s) is merely exemplary in nature and is in no way intended to limit the invention, its application, or uses.

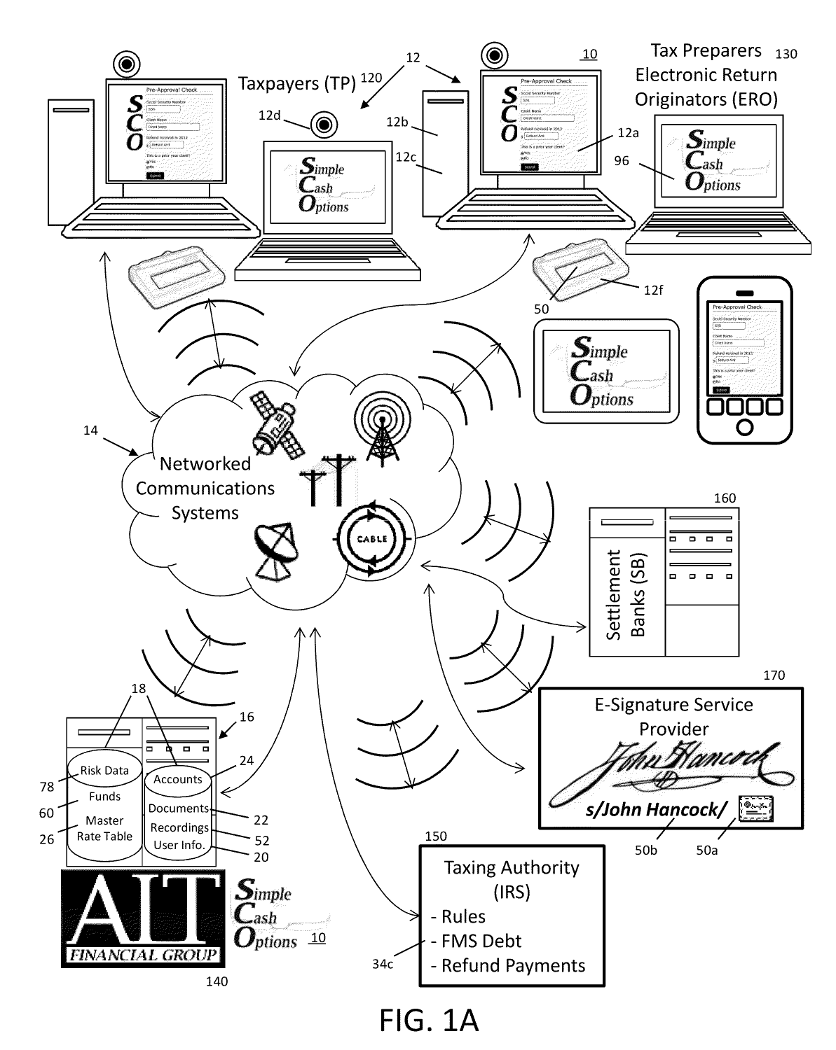

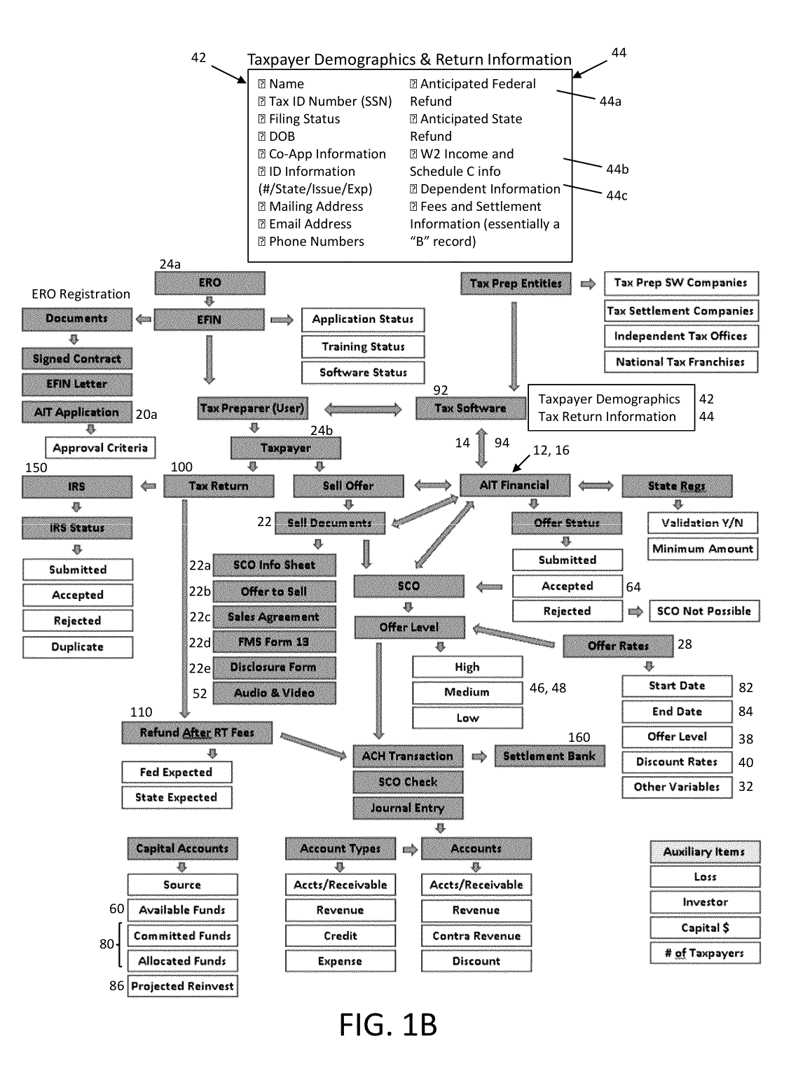

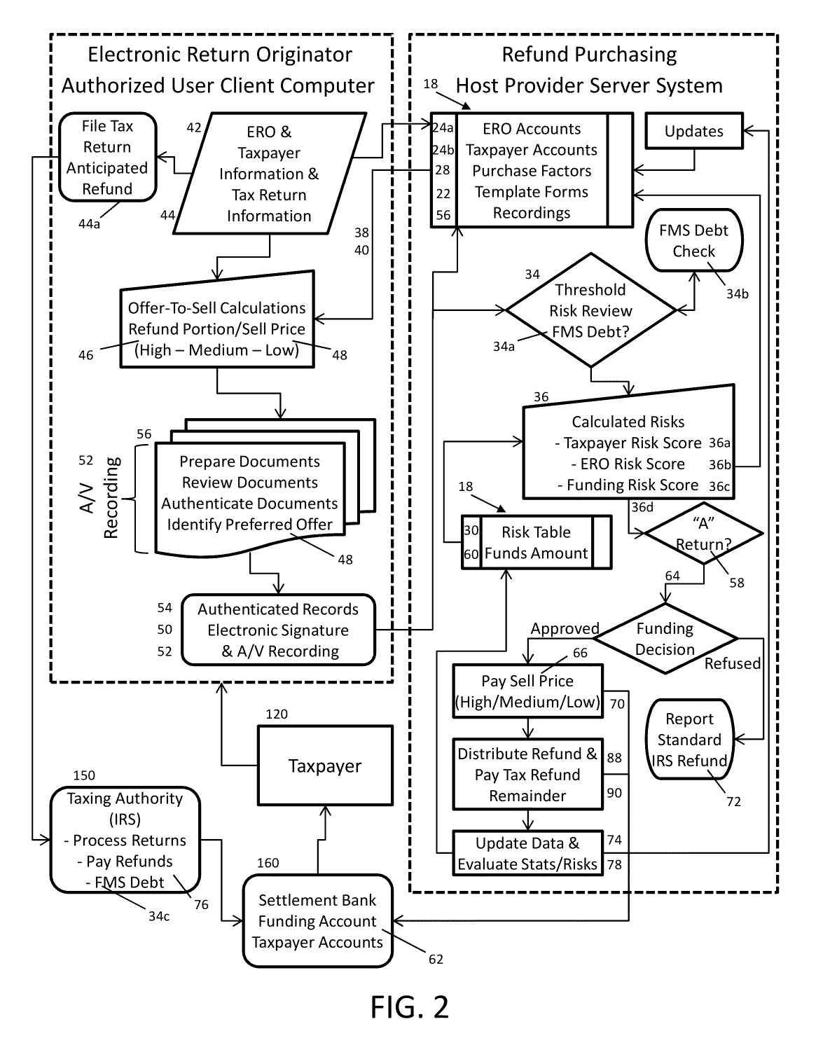

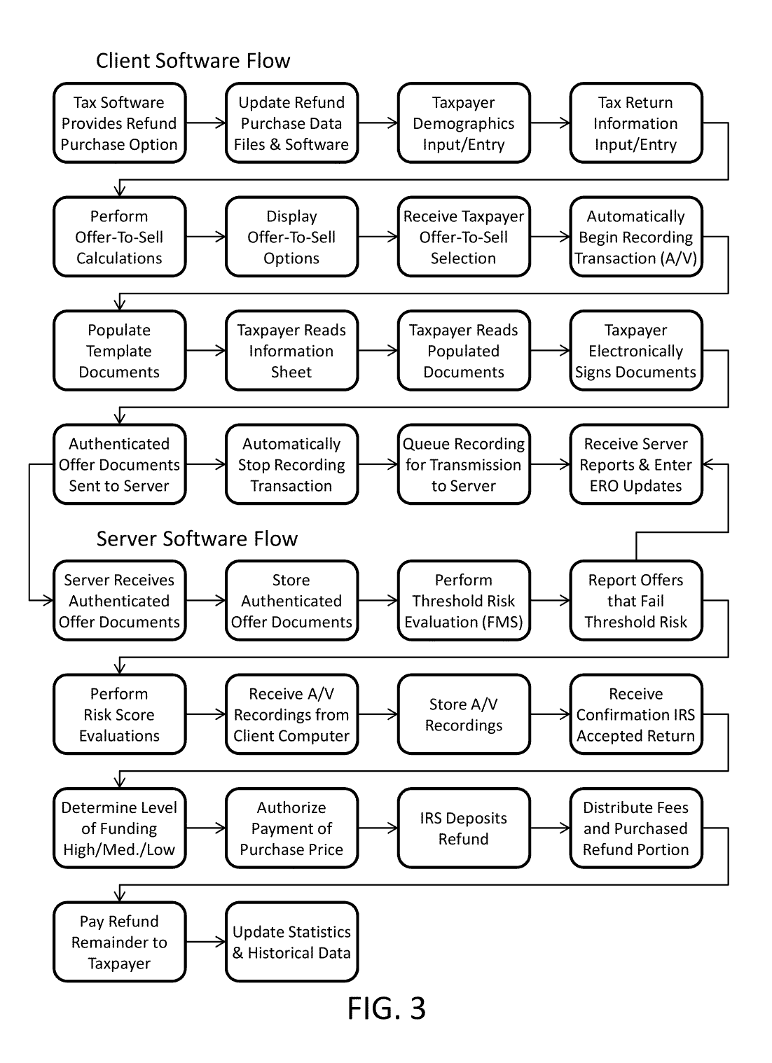

In one embodiment of the present invention, the system 10 automatically evaluates an anticipated tax refund 100 for purchase based on a tax return 110. An overview of the system is illustrated in the system diagrams of FIG. 1A and FIG. 1B, showing client computers 12 in networked communication 14 to the host server computer 16. The interrelationships between the client computers 12 and the server 16 are described in detail below with reference to the system diagrams. The operations that are implemented by the client computers 12 and the server 16 are described with reference to FIG. 2, and the particular steps performed by the software running on the client computers 12 are described with reference to FIG. 3. In the preferred embodiment, the server 16 maintains a database 18 that stores the information 20a of the client users in electronic return originator (ERO) user accounts 24a that are authorized to use the system 10, i.e., return originator accounts for authorized return originators. The database also contains taxpayer demographic information 42 and tax return information 44 on taxpayer accounts 24b that are uploaded from the ERO computers 12 and associates the taxpayer information 20b with the corresponding return originator accounts 24a.

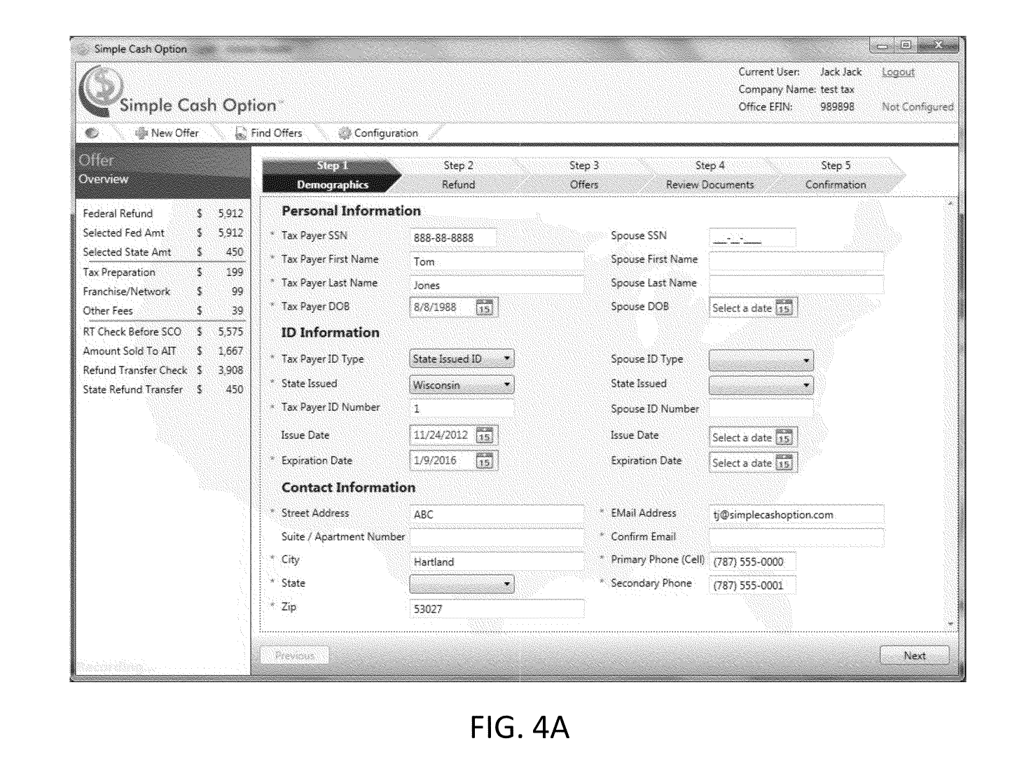

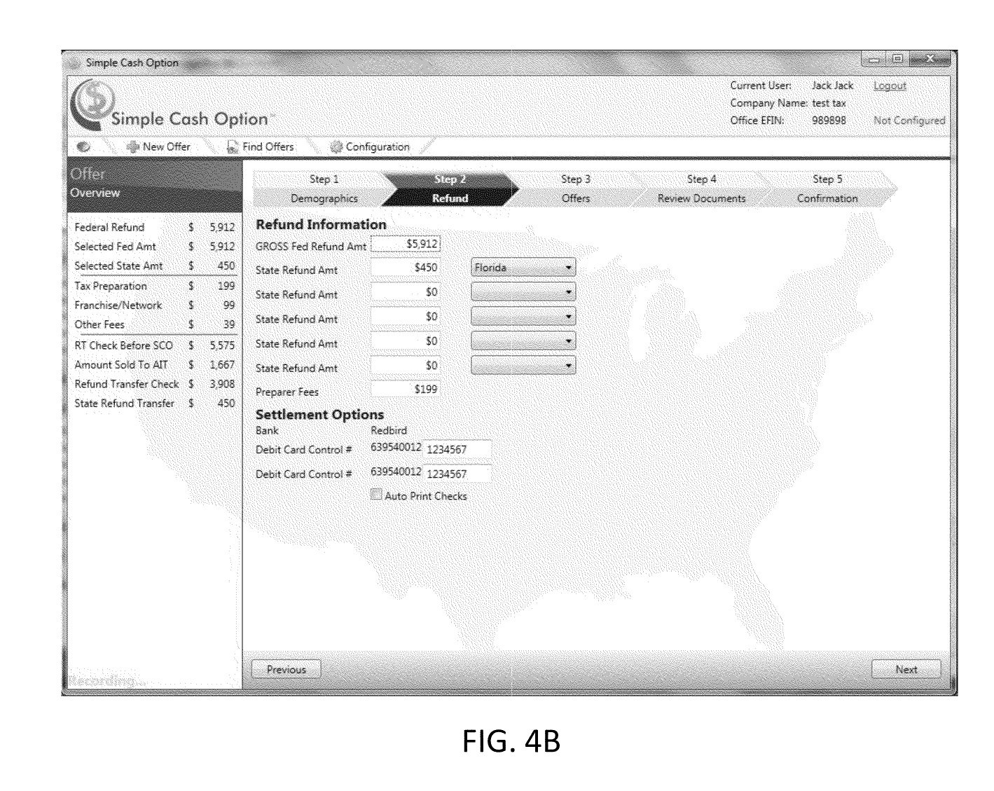

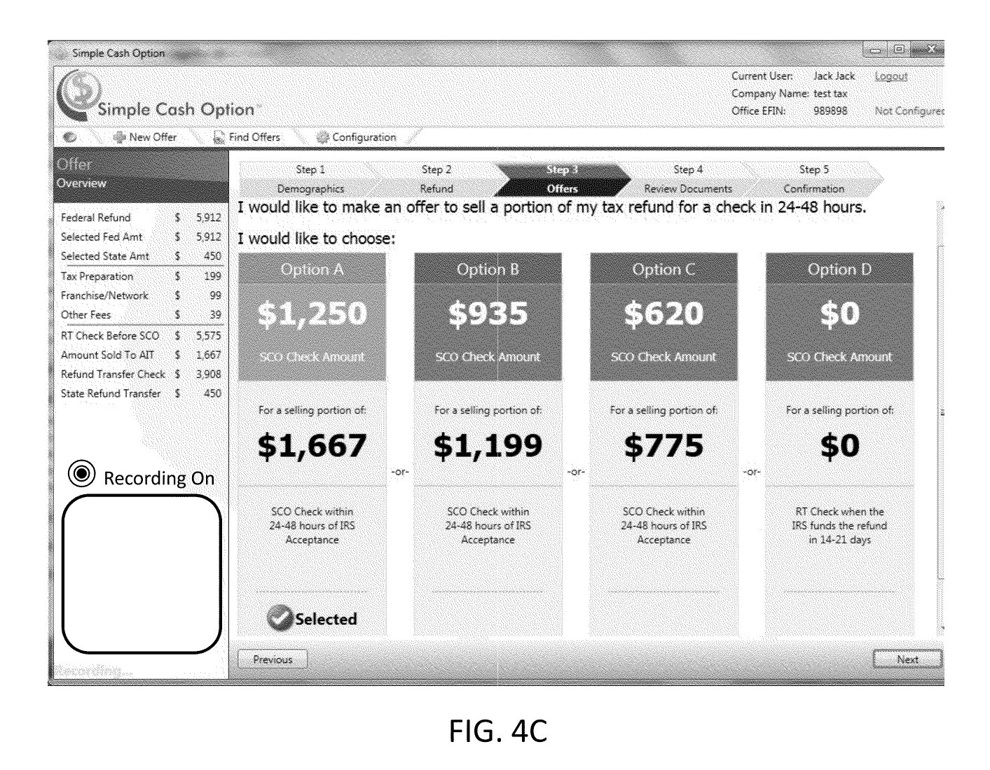

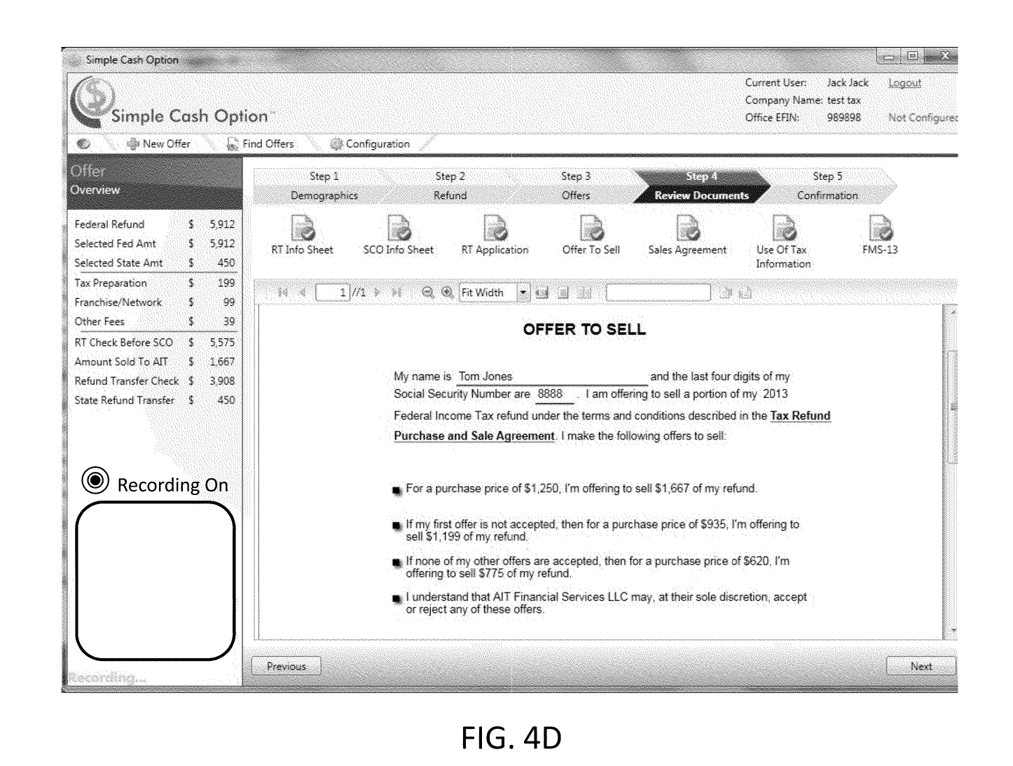

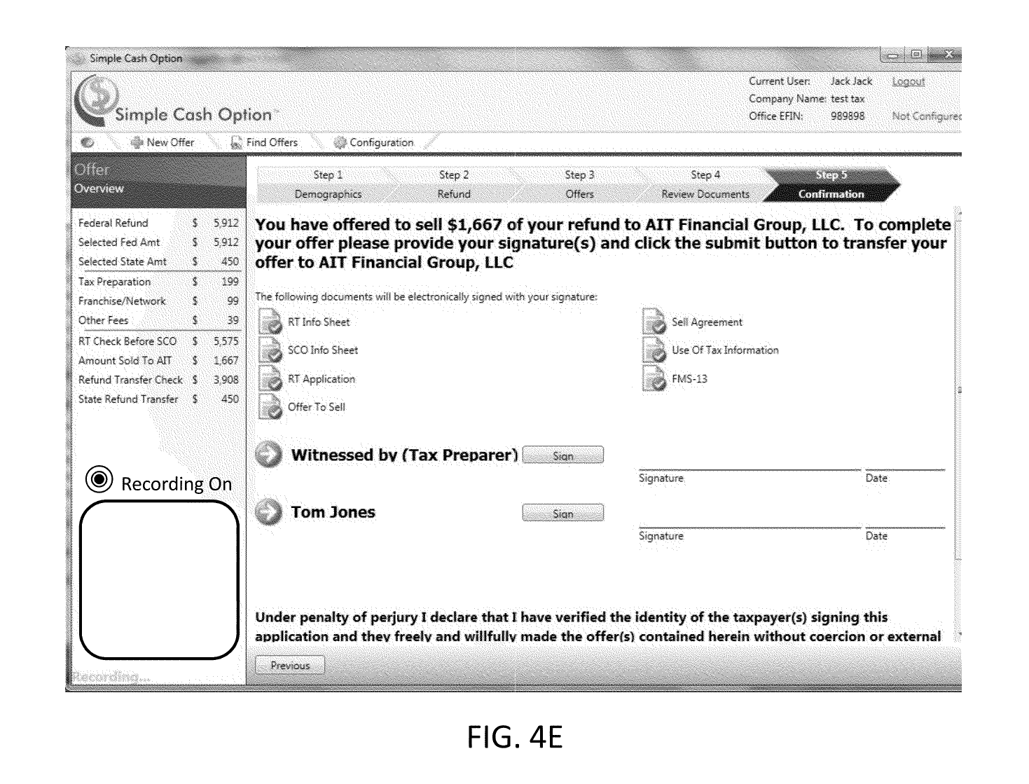

The ERO users 24a operate the system 10 in the presence of the taxpayers 120 they are serving so that the taxpayers can make a sell offer of a portion of their anticipated tax refund to one or more potential purchasers. The system can calculate a range of optional sell offers, X, for the taxpayer according to a portion of the refund (X1—high, X2—medium and X3—low), and the purchaser can choose to purchase a portion of the refund according to some discounted amount, Y<X, that is paid now (Y1—high, Y2—medium and Y3—low) in exchange for the right to the portion of the refund. The screenshots shown in FIGS. 4A-4E graphically illustrate the steps performed by the system software running on the ERO computers. An example of the optional sell offers and corresponding discounted purchase prices are shown in FIG. 4C.

The database 18 has at least one master rate table 26 which includes a plurality of purchase option factors 28 and a risk table 30 having a plurality of risk factors 32. Examples of the purchase option factors and the risk factors are described below with reference to the particular operations of the system. The purchase option factors preferably include one or more refund portion factors 38 and a set of discount rate factors 40. The risk factors preferably include threshold risk criteria 34a and risk tolerance criteria 36. The server 16 also maintains a centralized electronic document repository 22 that is shared with the client computers 12. The template documents in the repository are made available to the ERO client computers to provide the client side software with immediate access to the electronic documents in a local electronic document repository. As explained in detail below, the ERO computer 12 displays the electronic documents 22 for the taxpayer to sign with an electronic signature 50, including the offer-to-sell template 22b and at least one release authorization template 22d.

The ERO computers 12 have a display 12a, a processor 12b, a storage memory 12c and a recording device 12d. The processor runs the client-side software, and the ERO user 24a enters demographic information 42 for the taxpayers 120 and the corresponding set of tax return information 44 on the taxpayer account 24b. It will be appreciated that the ERO may manually input the information or the software may automatically enter the information by pulling it from tax preparation software. The tax return information 44 preferably includes an anticipated refund amount 44a, an income amount 44b and information on claimed dependents 44c. The processor 12 receives the refund portion factor 38 and at least one discount rate factor 40 from the master rate table 26 and uses the refund portion factor and the discount rate to determine a range of refund portions 46a, 46b, 46c of the anticipated refund amount 44a to be offered for sale and a range of sell prices 48a, 48b, 48c for the corresponding range of refund portions respectively. The processor 12b presents the optional sell offers 46, 48 on the display 12a for the taxpayer 120 to review and to select a taxpayer preferred offer 50 and also automatically populates the template forms with the required information. For example, the offer-to-sell template 22b is populated with the range of sell prices, the corresponding range of refund portions, and the demographic information, and the release authorization template 22d is populated with the taxpayer's demographic information but does not need any tax return information.

When the taxpayer has selected a refund portion that will be offered for sale, the processor automatically activates the recording device 12d during the time period 54 that the populated documents are shown on the display and while the taxpayer authenticates the documents. The taxpayer preferably vocalizes at least a portion of the documents that summarizes the terms of the sell offer while the processor creates a digital signature 50 uniquely identifying the taxpayer 120, and the processor produces authenticated records 54 with the digital signature associated to the populated documents. The recording device 12d produces a digital recording 52 of the taxpayer during this time period 56, and the processor saves the digital recording to the storage memory on the ERO computer before the authenticated records and the digital recording are uploaded to the server.

The server provides the networked communication interface for thousands of authorized ERO users 24a to connect using their ERO client computers 12 and thereby access the information stored in the database 18 for their respective accounts. The server receives from the ERO client computer processor the tax return information, the range of sell prices, the range of corresponding refund portions, and the digital signature for the authenticated records. The server coordinates a threshold risk evaluation 34 based on an FMS debt check 34b and the threshold risk criteria 34a. The server also determines a set of calculated risk scores 36a, 36b, 36c associated with paying the range of sell prices for the corresponding range of refund portions. The server compares the set of calculated risk scores 36a, 36b, 36c with the risk tolerance criteria 36. The server identifies at least one acceptable offer 64 having a sell price 66 in said range of said sell prices based on said set of calculated risk scores. The server authorizes a payment 70 of the sell price 66 to the taxpayer when a predetermined FMS debt status 34c satisfies the threshold risk criteria 34a and at least one calculated risk score in the calculated risk scores is within an allowable risk level 36d in the risk tolerance criteria and after receiving an approved return report 58 which will probably come from the ERO client computer 12 but may come directly from the IRS 150. As explained in detail below, the predetermined FMS debt status is a threshold risk 34 determined independently from the calculated risk scores 36a, 36b, 36c and is obtained pursuant to a release authorization 22d provided in the authorized records.

The server maintains current information on an available funds balance 60 for one or more funding accounts 62. When the server receives the authenticated records from the ERO users, the server prioritizes the evaluation of the offers in which there is no FMS debt so the threshold risk criteria is satisfied. For those offers with authenticated records that fail the threshold risk criteria because of FMS debt, the server sends a report 72 back to the ERO users 24a indicating that the offers are rejected. When the “A” return 58 is a mandatory condition for paying the sell price 66, this requirement can be viewed as another example of a threshold risk review similar to the FMS debt requirement.

Generally, the server prioritizes allocations of funds from the available funds balance to taxpayers whose offers are accepted according to a ranking of the calculated risk scores. As explained in detail below, the server can select the sell price from the range of sell prices according to the ranking of the calculated risk scores. When the tax refund is paid out, the server can also calculate a return accuracy factor 74 based on a comparison of the actual refund amount 76 with the anticipated refund amount 44a. This information can be collected for all of the ERO users 24a and their corresponding taxpayer accounts 24b and can correlates a number of statistical relationships between the return accuracy factors and the tax returns, including information on the ERO users and the taxpayers. A primary statistical indicator 78 for the return accuracy factor can be evaluated relative to the income amount 44b in the tax returns 110. When the tax refund is received, the server 12 disburses a payment distribution 88 to the appropriate parties, and the remaining portion 90 of the refund is provided to the taxpayer.

There are a number of calculated risk scores that can be used in the present invention, including a taxpayer risk score 36a, a return originator risk score 36b and a funding risk score 36c. Each of these risk scores is described in detail below. Generally, the taxpayer risk score 36a is based on tax return information 44, the proposed sell prices 48 and the corresponding range of refund portions 46 of the anticipated refund amount that are offered for sale. The funding risk score 36c is based on the available funds balance 60, an amount of funds already spent 80 during a tax season time period 82 or otherwise already committed, a remaining time in the tax season time period 84 and historical weighting factors 86 corresponding with the remaining time. The funding risk score 36c may also include weightings for W-2 income returns and Schedule C income returns with returns having Schedule C income having a greater risk factor than the returns with W-2 income. The return originator risk score 36b is based on a comparison of historical ERO user information in the database, an anticipated return rate from the ERO user, and an actual return rate from the ERO user. The historical information can be based on the individual ERO user as well as the ERO users as a group. Details of the risk reduction techniques according to the examples of the present invention are described below.

### Risk Reduction Techniques

The ERO user accounts are authorized to access their information in the database, but not all information in the database is available to the ERO users. For example, in the case where the system software that resides on the ERO client computer uses data from the master rate table to perform the calculations for the optional offers, only the information from the master rate table that is necessary to perform the calculations should be provided to the software running on the ERO client computer the information, and this information is only used within the client software and is not directly accessible by the ERO users as raw data tables. As explained below, the server also maintains other data tables that are not accessible to the ERO users or the client software, such as available funds and statistical records.

In the preferred embodiment of the present invention, several evaluations are performed to reduce the risk of accepting a sell offer. For example, with regard to the present purchase of a right to a future tax refund, there are four (4) levels of evaluation for the risk analysis. In the first level, the IRS must accept the return as a “clean” return, i.e. an A—return/accepted, but not an R—return/rejected or nor a D—return/duplicate. Generally, this level of the analysis is an evaluation by an objective third party according to their own set of criteria which would rise to the expected right in the future payment. The third party could have its own categories of results for the evaluations according to its criteria, such as the IRS categories of an A—return, R—return and D—return.

Of course, other third parties would have their own categories according to their own criteria and rules for evaluation and reporting. For example, structured settlements could be categorized based on an underlying claim in a court proceeding, such as an individual tort, a class action tort, a bankruptcy proceeding, a judgment on a breach of contract or insurance claim or infringement of a patent, trademark or copyright, and other categories of cases that may be tracked by the systems implemented by state or federal courts, such as the PACER system. Accordingly, the initial analysis of the third party could be the categorization of a case by a court. Another example would be a viatical settlement of a life insurance policy for a terminally ill person or some other life settlement on a life insurance policy. Where it is allowed by the governing laws and regulations, it is possible to apply the present invention to evaluate the potential purchase of any insurance payment benefit for a present value payment.

The system of the present invention may only accept certain sell offers based on the categories that the third party determines. For example, as indicated above, in implementing the inventive system for purchasing a future interest in a tax refund, the system will only evaluate returns that the IRS categorizes as A—returns and will reject R—returns and D—returns. In another example, a purchase of a structured settlement may only be considered for monetary damages awarded to an individual for a tort where the individual's attorney provides the records for an insurance company that is bound to the judgment according to the insurance policy terms with the defendant.

The second level of evaluation is a preprogrammed set of qualifying criteria that is defined within the computerized system in order to automatically determine whether the offer fits within preprogrammed qualifying criteria or is outside of the criteria. For example, when purchasing a future interest in a tax refund, the system may only accept returns that have particular types of income and standard deductions. Accordingly, the preprogrammed qualifying criteria for the tax returns may require only W-2 income so that sell offers for tax refunds that are based on returns with non-W-2 income may be rejected. For example in the preferred embodiment, sell offers would be rejected when the underlying tax return includes income from self-employment, farm, renal, royalties, or capital gains. Similarly, acceptable sell offers may be limited to tax refunds that are based on tax returns with standard deductions whereas tax returns with nonstandard deductions are rejected. For example, children as dependents would be an acceptable deduction because children as dependents is categorized as a standard deduction, but sell offers could be rejected based on tax returns with nonstandard dependents because these are categorized as nonstandard deductions, such a father, mother niece, nephew, brother, sister, grandmother and grandfather.

It is also possible to incorporate a standard deviation criteria based on a mathematical analysis of the tax return. For example, the system could pick a certain indicator such as Gross Income and determine that returns with Gross Income between a particular income range (A-B) should have refunds between another range (X-Y). With this information, the system can determine how far a particular refund may be out of the “norm” for the income in a corresponding return based on standard deviations. The risk tolerance of the system can be adjusted to accept or reject all returns outside a particular number of standard deviations (N). The system can accumulate additional data from the returns that are accepted and purchased and can assign a success criteria for the purchase (i.e., return accuracy factor: actual refund amount relative to the anticipated refund on the return, return burn factor: loss based on accepted sell offer when actual refund amount does not cover purchase price). Additional statistical modeling in the system can perform several different types of analyses on any various indicators, such as Gross Income, Adjusted Gross Income, Taxable Income, Number of Dependents, Amount of Earned Income Credit, Amount of Education Credit, Amount of Child Tax Credit, Amount of Additional Child Tax Credit, Number of W-2's, Anticipated Refund, Actual Refund, as well as other criteria.

Another check for potential fraud or outlying return indicators may be examined based on the tax preparer or electronic return originator (ERO) that is using the system. Using historical data and statistical calculations, the system can evaluate whether the ERO is producing the anticipated percentage of the total returns. For example, the system can model the number of current year returns based on the number of returns done by the ERO in prior years. For example, if Tax Preparer I entered one hundred (100) returns into the system last year and in total all of the EROs using the system entered one thousand (1,000) returns last year, the system would have a normalized return rate for Tax Preparer I generating approximately 10% of the total returns in the system on any given day. If Tax Preparer I generates some predefined higher rate of the system's total returns in a particular day, such as 15% or 30% depending on the desired tolerances, a flag would be tripped in the system that calls for additional evaluations of the situation or other procedures. For example, the system may guide an administrative user through a review of a random sampling of the transaction, possibly using information from the audio/video/screen capture system, to determine if the transactions were done in accordance with the guidelines for using the system and providing the sell offers.

The system may contact Tax Preparer I to inquire about the large volume of returns that the preparer or the preparer's firm is generating; the contact may be automatically generated or may provide information and guidance to the administrative user in making personal contact. Additionally, the system may request that Tax Preparer I forward copies of documentation for selected files, such as a copy of the W-2. Based on the findings, a system manager could release the returns for normal processing, manually review the offers to determine acceptance or take disciplinary action against the ERO. With these steps, the system is trying to capture and eliminate a dishonest employee or a dishonest ERO that is falsifying data to increase their volume. Just as before, the standard deviation in the system can be adjusted from the expected production levels (in this example 10%) that the system managers and purchasers of the assets are willing to accept. It will be appreciated that the techniques discussed above can be performed manually or may be fully automated within the computerized system, or they may be semi-automated, such as when the system provides guidance to the administrative user or manager when they are personally contacting an ERO.

An additional risk reduction technique is based on the number of sell offers that are received and the amounts of the sell offers as compared with the amount of funds available to satisfy the sell offers at risk levels that are acceptable to the purchasers. In a supply and demand model, if there are more than enough acceptable sell offers than the funds available to satisfy the sell offers, the system may prioritize the sell offers to fill the lowest risk sell offers first and then with any remaining funds begin filling another set of sell offers that have the next higher risk level. Additionally, since the system creates a high, medium and low offer for the sell price, it is also possible that the system can accept the lower offer sell price for certain transactions, and this may be performed via random selection for a set of transactions that otherwise have an equal risk factor. For example, the system can reduce every fifth (5^{th}) return that came in during a particular period of time, which may be daily (as opposed to the last 15 returns that came in). This way, the system's decision to accept a reduced offer won't discriminate against taxpayers of an ERO that opens early or closes late.

In determining the amount of funds available to purchase the assets, the system can also evaluate historical trends. For example, with respect to tax returns, based on historical RAL data, it can be expected that approximately 75% of the returns that pass through the system will be submitted by January 31 of any given year. Accordingly, the system can calculate the purchase funds available in this early return period based on 75% of the total purchase funds that are available for the entire tax season. Similarly, in the first half of February, approximately 15% of the returns are submitted and then 10% of the returns are submitted in the second half of February and the remaining purchase funds can be allocated accordingly. In this way, the acceptance of high, medium or low sell offers can be based on historical data.

As generally described above, additional risk avoidance techniques can also be used. For example, as discussed in detail below with respect to the purchase of the sell offer for the tax refund, the system can require particular steps of a deal's process to be captured with audio and video that the taxpayer must enable or the system will prevent the deal from being finalized or otherwise executed. As discussed in detail below, the preferred embodiment of the inventive system is implemented by software that runs on a computer network, and when the seller/software user gets to particular steps in the process, the seller must enable the recording features of the system in order to proceed to the next step in the process. Additionally, the execution of the documents using electronic signatures can be verified using authorized electronic signature service providers, such as DocuSign.

### Tax Refund Examples

The steps of the inventive system are generally shown in FIG. 2 for an example where a taxpayer (TP) is provides a sell offer of at least a portion of a tax refund. Also, an exemplary flow of software operations is shown in FIG. 3 for the software in the client computers 12 and in the host server 18. This example is further described below followed by a detailed step-by-step description. The interactive steps between the client computer and the server are also graphically illustrated by the screenshots in FIGS. 4A-4E.

As shown in FIGS. 4A and 4B, using an internet web based software application, the system prompts for the Taxpayer Name, Taxpayer Identification Number/Social Security number (SSN), Address, Phone, Email, Refund Amount and Preparer Fees. Settlement options and other transaction details may also be entered.

As generally explained above, the inventive system 10 uses formulas and variables factoring in the risk threshold and cost per $100 to automatically generate and present options to the taxpayer that a potential buyer would consider if a portion of the anticipated refund were to be offered for sale at a discounted price. The first variable is based on how much the potential buyer would be willing to put out on the street based on the money that it has available. The second set of variables are the discount rates with a highest tier $100 discounted by $A (A%), a middle tier discounted by $B (B%) and the lowest tier discounted by $C (C%). The upper tier discount may be larger than the lower and middle tier discounts (A%>C%, A%>B%), but this is not necessarily a requirement of the system 10. Three options of exemplary offers are shown in FIG. 4C (Option A, Option B, and Option C) along with a standard refund transfer product (Option D).

When the initial information is gathered, the system 10 first looks at the taxpayer's SSN. The system history is checked to determine if the taxpayer's SSN was used in prior years and if it was fully funded by the IRS. Some taxpayers may have FMS debt and/or prior IRS debt and therefore their refund may be garnished for the amount they owe. The database in the server keeps track of the percentage of funding received for prior transactions and uses this information to score the taxpayer's risk. If a taxpayer received 0% of their refund last year, they probably still have outstanding debts and we would decline their application.

Next, the system performs a search for new FMS debt using an auto-dialer that calls the FMS hotline, enters the SSN and gets a response. The response is parsed electronically to determine if the FMS debt amount was $0. If it's not $0, the application is declined. Similarly, the system reviews the taxpayer's historical tax data (with permission from client & authorization as agent, power of attorney or CPA) to determine if the taxpayer has outstanding debts to the IRS. If outstanding debts exist, the application is declined.

The system can also evaluate the ERO (tax preparer) who is submitting the application. First, the system evaluates the cumulative funding percentage for an ERO. Secondly, the system looks at what percentage of our dollar volume is originating from one ERO. The system monitors this to ensure that one ERO is not submitting unusually large or fraudulent returns. This is viewed and can be flagged manually as a variable in the system. Looking at these two items on the ERO generates an ERO Risk Score. If the score is within the ERO Risk threshold, then application proceeds, otherwise it is declined. One example of a score is the standard deviation model.

Assuming an application passes the Taxpayer Risk Score and the ERO Risk Score, the next step is to prepare offers that the taxpayer may want to offer for a portion of their anticipated tax refund. There are a number of ways to calculate the offer. In one example, the system can use an mrpp (Maximum Refund Purchase Percentage) that is a variable number which can be set to some number that is under 100%. The system takes the federal refund amount, less fees, and multiplies it by the mrpp. This determines the top tier sell price that the potential buyer is willing to pay, i.e., aittoppriceamount=(refund−fees)*mrpp. Then, the system factor that amount by our top tier cost per $100 (topcp100, i.e., 100%+C%) to generate the amount of the refund purchased (aittoppurchaseamount=aittoppriceamount * topcp100). That completes the top tier offer (aittoppurchaseamount>aittoppriceamount).

Next, the system can determine a minimum offer variable amount which can be based on the lowest price that the potential purchaser would entertain to make the transaction worthwhile for the costs involved or could be based other criteria as explained below. The system factors that number by the low tier cost per $100 to generate the aitbottompriceamount and the aitbottompurchaseamount. Another criterion to determine the lowest price may be a minimum amount to comply with state laws. Another criterion may ensure that the refund purchase system is not reclassified as a loan.

To generate the middle tier offer, the system takes the difference of the top and bottom offers and multiply by a variable (middlepriceamountfactor), then add it to the bottom price amount. So, if the top price is $1600 and the bottom price is $600, the difference is $1000. That is multiplied by the middlepriceamountfactor (0.6) and added to the bottom price to determine the middle price ($1200). Then, the system factors the middle price by the middle tier cost per $100 variable to determine the middle purchase amount (aitmidpurchaseamount). That completes the three offers. More calculations are made once the IRS accepts the return.

Once the taxpayer decides to make a sell offer to the potential buyer, the software presents the associated fees for the taxpayer to review via an RT Info Sheet. Next we present a scripted statement for the taxpayer to read to ensure they are fully aware and understanding the agreement in which they are engaging. The system software on the local client computer 12 records the audio and video of the taxpayer reading the Offer to Sell statement.

Next, using the industry standard and legally proven method of electronically capturing signatures, all the necessary forms are signed via an e-signature service provider, such as DocuSign. The AIT system may use a signature capture pad 12f to create the electronic signature 50 for the taxpayer 120 and may use a digital certificate 50a along with the video recording 52 to create a digital signature 50b that supports the authenticity of the signature.

The electronic forms for each transaction will reside on the ERO computer but do not need to be transmitted to the server because the server maintains the template version of the forms in its centralized electronic document repository. Accordingly, the signature files do not need to be bound to the electronic documents and can instead be assigned to the offer data stream which includes the taxpayer demographic data and the financial offer data that make up the transaction. The system can validate the signature based on the storage of the time-stamped intact data stream. The system can invalidate the signature if the data stream is later changed. Of course, the ERO computer can also print out copies of the documents showing that they have been executed with the taxpayer's digital signature. The electronic document repository 22 can store any document that may be used for the transaction, including a Refund Transfer Information Sheet, 7216 Form (Disclosure or Use of Tax Information by Preparers of Returns), Sale Disclosure Statement, FMS Form 13 (Authorization for Release of Taxpayer Information), Offer to Sell Statement, and Tax Refund Purchase and Sale Agreement. Each one of the forms listed on FIG. 4D are generally described below.

The SCO Info Sheet 22a is an information summary document that is populated with the financial information for each of the three offers calculated by the system along with the option to decline the offers and process the refund using the traditional refund transfer process.

The Offer to Sell document 22b is a sales disclosure statement populated with the identification of the taxpayer and a summary of the offer to sell a portion of the tax return. The summary of the offer includes the buying and selling prices along with a statement of understandings from the taxpayer in regard to the sale.

The Sales Agreement document 22c is the detail agreement between the taxpayer as the seller and the service provider as the buyer which includes the particular terms of the agreement.

The FMS Form 13 document 22d is an official authorization for release of taxpayer debt information from the Financial Management Service of the Department of the Treasury which manages debts for Federal and State agencies.

The Use of Tax Info document 22e is a disclosure statement and consent form that is required by the IRS to obtain an authorization to use the taxpayer's information to process the return using the system. This disclosure and consent is commonly referred to as complying with IRS “Section 7216”.

The tax preparer's software vendor submits the return to the IRS for acceptance. Upon being accepted by IRS, the software vendor electronically pushes a copy of the Return (A Record) and the Return's Payment Information (B Record) to the host server.

The host system is able to access all necessary information to process the purchase from the A and B records. The system reviews the routing number and account number to ensure that the refund has been directed to the proper banking partner. When we review the name, SSN and refund amount to make sure it matches the initial information we received. Additionally, we perform our risk analysis on the return, and we reserve the right to decline the transaction.

Assuming the information is acceptably accurate, we next evaluate the status of AIT funds available for purchases. Using formulas to compare the percentage of season completed to the amount of purchase funds spent we generate an AIT Funds Risk score. Based on a table of scores and corresponding acceptable risk percentages, we may or may not accept one of the offers made by the taxpayer for the sell offer of their refund. This decision is computerized and based solely on size of the purchase relative to the AIT funds risk. No taxpayer demographic information is necessarily evaluated at this step. Accordingly, AIT's decisions may be protected from accusations of discrimination against particular taxpayers. In an alternative embodiment of the system, we may bump taxpayer purchase offers down to a lesser purchase size and lower cost per $100.

The system can also run the Financial Management Service (FMS) check as well as an IRS debt check before issuing a check to the taxpayer. For the FMS debt indicator, the system can be programmed to automatically or semi-automatically check a taxpayer's FMS information using the toll free number and the taxpayer's SSN. In the automated method, the system would record and parse the FMS automated telephone message, and in the semi-automated method, the system would guide the administrative user through the steps and provide the data field in which to enter the information retrieved from the FMS automated telephone message. The FMS message could indicate that monies other than back taxes are owed, such as back child support, government-backed student loans, Veterans Administration benefits, and other FMS criteria. For back taxes information from the IRS, written permission is required from the taxpayer and a manual process is then followed. However, with the advent of the present invention, particularly combination of the audio/video recording with the execution of electronic documents using e-signature service providers, the present invention will be extended to automatic systems, including the use of auto-dialers, when it becomes feasible to do so with the IRS systems.

There are also some other alternative checks that can be performed. When the initial information is gathered, we look first at the taxpayers SSN to make sure it matches what information is in our system. Next we verify the routing number and account number on the 1040 match our routing number and account number syntax. Secondly, we look at the ERO (tax preparer) who is submitting the application. First we evaluate the cumulative funding percentage for an ERO. Secondly we look at what percentage of our dollar volume is originating from one ERO. We monitor this to ensure that one ERO is not submitting unusually large or fraudulent returns. This is viewed and flagged manually as a variable in our system. Looking at these two items on the ERO generates an ERO Risk Score. If the score is within our ERO Risk threshold, then application proceeds, otherwise it is declined. For example, if the AIT Funds Risk Score is 0.4, we have a corresponding risk variable of 0.00025. We divide each tier's price by the funds available. If that percentage exceeds the 0.00025 risk variable we cannot accept that tier and would bump down to the lowest accepted tier, or decline the Simple Cash Option (SCO) tax refund purchase all together. That moves the taxpayer to a standard RT (refund transfer) product.

Once an offer is officially accepted by the AIT software, a report showing approved checks, amount, and payee information is generated and an electronic check print file is sent to the ERO. It will be appreciated that in an alternative embodiment, the payment authorization may be held for a period of time (such as a 2 hour period) as may be required by a purchaser for their independent review to ensure no fraud is being perpetrated against the AIT Purchase Funds or when there is some outlying data in the record.

After the SCO tax refund purchase check information is issued, the check information is sent to a settlement company to process the fees and disbursement of the refund via check, cash card, or ACH deposit. The information is also sent to our banking partner for check verification purposes. The software offers a portal to allow the tax preparer to check the system for refunds available to be disbursed. The software will print checks that include a disclosure of fees and place for taxpayer to sign that they have received the check. Once the IRS deposits the refund into the bank account, the AIT system will disburse the fees to the bank, settlement company, and AIT and issue a check for the remaining amount to the taxpayer via the check print portal accessed by the tax preparer. Additionally, we have an AIT management portal allowing for report printing, accessing taxpayer records, modifying our decision formula variables, viewing the a/v capture and creating and editing users.

It will be appreciated that the flow of software operations can be changed so that all of the offer-to-sell operations are performed in the host server. For example, as shown in FIG. 1B, it is possible for the tax software 92 on the client computer 12 to operate with the server 18. In such a case, when the taxpayer demographics 42 and tax refund information 44 are sent to the host server, the processor in the server performs all of the offer-to-sell calculations. Many tax software applications are web based so that the server can display the options and receive the selections. Additionally, an interface 94 for the tax software to the server can be incorporated as an additional module 96 to the tax software so that it can perform the local functions, such as preparing and authenticating the documents as well as recording the transaction. Accordingly, the examples for the cooperation between the host server 18 and the client computer 12 are not intended to limit the implementation of the system 10. Instead, the examples indicate that the system can be implemented in different client-server configurations.

The step-by-step process is listed below.
1. ERO prepares taxes & determines refund
2. ERO goes to AIT site, enters SSN & Name, Joint SSN & Name, Address, Phone, Email, Federal Refund Amt, State Refund Amt, & Preparer Fees
3. AIT—Receive “Initial Information” & determine purchase price & purchase amount.
4. (Optional) Perform initial risk analysis
5. Present Offer Options on screen
6. TP reviews our three offer options & selects one of the offers, thereby agreeing to that offer or a lower offer. Offer selected on AIT software screen & submitted.
7. RT Info Sheet on screen display shows fees.
8. ERO reviews RT Info sheet with client. And selects Next to proceed.
9. Offer selection recorded. “Offer to Sell” agreement displayed on screen. Webcam & audio turned on.
10. Client reads & signs “Offer to Sell” document A/V captured & uploaded to AIT.
11. Sale Agreement, Sale Disclosure, FMS Form 13, 7216, RT Info Sheet, Offer to Sell statement, Bank Account Application presented for signature
12. Client signs documents on screen, tax preparer prints all documents for client.
13. In tax prep software, preparer identifies AIT product selected
14. Tax Return is submitted to SV for e-file—Bank Prod Application (B Record) & Electronic Return Sent
15. SV e-files tax return & receives accepted ACK (IRS 3 to 24 hrs)
16. If AIT Indicator present, SV pushes B record & Electronic Return (A Record) to AIT
17. AIT receives A & B Records
18. Compare “Initial Information” to electronic refund file. Re-evaluate return, TP risk, ERO risk, AIT Funding risk
19. Offer accepted or bumped to lower tier?
20. If Step 19 is YES, TP Record Status changed to Check Ready. Send check & fee information to SB via web services
21. SB Receives A Record, B Record, makes check available to print
22. (Optional) Other modifications?
23 If YES, follow option & if NO, continue.
24. If Step 19 is NO, TP Record Status changed to DeclinedtoRT
25. ERO goes to AIT website for status
26. TP Record Status Check Ready?
27. When TP Record Status Check is Ready—ERO links to Atlas check printing system, marks check for print, loads checks, enters starting check number & prints
28. Pull check information & status from Atlas, record in TP record
29. Call TP to come in & pickup check
30. Taxpayer accepts/rejects check
31. Accepts—TP picks up check
32. Renects—TP Record Status changed to AwaitingVoidSignature
33. Initiate manual process to resolve “cooling off period” decline.
34. SB Receives funds from IRS or State
35. AIT receives notice of funding, records in TP Record for future scoring of ERO & TP
36. SB Disburse fees to AIT, SV, ERO as detailed in web services record.
37. SB Makes check available for remaining refund amounts
38. ERO Checks Atlas site daily for check print availability
39. Normal Bank Product Check printing process is followed.

Generally, for the tax refund example, the inventive system provides a nonrecourse vehicle and noncredit model for producing sell offers on a taxpayer's anticipated refund. In the event that the IRS does not provide the refund to the settlement company, the buyer of the asset, i.e. the anticipated refund, has no recourse absent fraud to retrieve the purchase price from the taxpayer. According to the business model of the tax refund example, the purchaser of the asset is the first party to receive the proceeds from the actual refund. Therefore, if the purchaser paid $1,200 for $1,500 out of a total anticipated refund of $5,000, and the taxpayer only gets $3,000 for the total actual refund, the purchaser is paid in full ($1,500) but the entire transaction would only have a return accuracy factor of 60%. In the event that the total actual refund is only $1,080, the purchaser gets the entire refund amount and the taxpayer does not get anything; in this situation, there would be a “burn factor” associated with the transaction based on the $120 loss which would be a 10% loss of the original investment, and the return accuracy factor would only be approximately 22%.

The embodiments were chosen and described to best explain the principles of the invention and its practical application to persons who are skilled in the art. As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. For example, only a general description is provided for e-signatures and any type of e-signature system could be employed with the inventive system. Generally, electronic signatures use any type of electronic means to indicate either that a person adopts the contents of an electronic message, or more broadly that the person who claims to have written a message is the one who wrote it (and that the message received is the one that was sent). Digital signatures are a particulate type of electronic signatures that use digital certificates to support the authenticity of a digital message or document. A valid digital signature gives a recipient reason to believe that the message was created by a known sender such that they cannot deny sending it (authentication and non-repudiation) and that the message was not altered in transit (integrity). Digital signatures are often used to implement electronic signatures, a broader term that refers to any electronic data that carries the intent of a signature, but not all electronic signatures use digital signatures.

### Overview of General System

As shown in FIG. 1, a person could have a presently expected right to a future payment that the person wants to monetize immediately for some amount less than the full future payment amount rather than waiting for the full payment in the future. The present invention provides an automated system for the person to monetize their future payment at a present value by selling the future payment or a portion thereof for a present payment. The system receives the sell offer from the seller and performs the threshold evaluation based on a qualifying criteria that is designed to reduce the risk of the transaction. Several risk reduction techniques of the system are described in detail below, and these risk reduction techniques can be used in combination or apart from each other. Additionally, these risk reduction techniques can be used in situations where parties are contemplating other types of deals to provide immediate value to an asset that has a future value, particularly including bartering and trading situations as well as loans and credit such as described in some of the prior art references cited above.

In the event that the threshold evaluation is not met according to a third party's categorization of the asset being sold or a preprogrammed set of qualifying criteria, the sell offer fails and the system prevents the deal from being consummated. For sell offers that pass the threshold evaluation, the system may allow for an examination of the underlying documentation or judgment that gave rise to the creation of the asset in order to determine whether there could be the potential for fraud in the transaction or other risk levels based on historical data. If the system determines that there is a fraud risk, it may prevent the deal from being consummated. Alternatively, if the system determines that there are some outlying data points from the standard acceptable risk tolerances (such as based on particular standard deviations from a norm), the system may flag the deal for a more detailed evaluation to determine whether the deal may still be acceptable. It will be appreciated that a deal with an increased risk may result in a lower purchase price than the seller had originally offered as the sell price for the asset.

For deals that do not have the risks associated with potential fraud and/or otherwise fit within the standard risk levels defined by the system, the system calculates the present purchase price for the asset which has a future value. The system then provides the seller with documents that formalize the deal and guides the seller through the process to consummate the deal. In consummating the deal, there may be an additional risk avoidance technique in which particular steps of a deal's process are captured with audio and/or video that the seller must enable. If the seller fails to enable the recording, the system will prevent the deal from being consummated.

Although the present system is described and illustrated as a stand-alone system, it will be appreciated that any of the patentable inventive aspects can be incorporated into other systems. For example, the entire system or just risk reduction techniques and/or risk avoidance recording steps may be integrated into professional tax preparation software and/or bank settlement software. The inventive system and its features can be produced in an agency-user version where information is pulled automatically from tax preparation software and/or in a direct-user where the tax preparer uses a third party tax preparation software program, such as TurboTax, and enters all of the information into the system for themselves. Of course, it is possible to integrate the present system into a web-based version of a tax preparation software program such as TurboTax. Thus, the breadth and scope of the present invention should not be limited by any of the above-described exemplary embodiments, but should be defined only in accordance with the following claims appended hereto and their equivalents.

What is claimed is:

1. A system for automatically evaluating an expected right to a future payment for purchase, comprising:
a database comprising information on a plurality of authorized user agents and corresponding user agent accounts and respective sets of information on a plurality of right-holder accounts, wherein said database further comprises at least one master rate table having a plurality of purchase option factors and a risk table having a plurality of risk factors;
a computer processor receiving from one of said authorized user agents a set of demographic information and a corresponding set of right-holder information on a right-holder account, wherein said right-holder information includes at least one future payment amount, wherein said computer processor receives at least one purchase option factor from said master rate table and uses said purchase option factor to determine a proposed sell price for at least a portion of said future payment amount to be offered for sale, and wherein said computer processor creates an authenticated record of an offer-to-sell for said proposed sell price for said portion of said future payment amount, said authenticated record correlating said offer-to-sell with said right-holder account;
a server providing a networked communication interface, wherein said authorized user agents access said user agent accounts in said database through said networked communication interface, wherein said server receives from said computer processor said right-holder information, said proposed sell price, said future payment portion offered for sale, and said authenticated record of said offer-to-sell, wherein said server determines a calculated risk score associated with paying said proposed sell price for said future-payment portion in said offer-to-sell and compares said calculated risk score with a risk tolerance criteria, wherein said risk tolerance criteria is retrieved from said risk factors in said database.

2. The system of claim 1 wherein said future payment is a tax refund and said right-holder accounts are a plurality of taxpayer accounts.

3. The system of claim 2 wherein a first set of said purchase option factors is comprised of at least one refund portion factor and a second set of purchase option factors is comprised of a plurality of discount rate factors.

4. The system of claim 1 wherein said authenticated record further comprises a release authorization for information pertaining to a predetermined status of said right-holder according to a set of categories defined by an objective third party, wherein said release authorization and said offer-to-sell are electronic documents populated with sets of information from said demographic information, said right-holder information, said proposed sell price and said portion of said future payment amount.

5. The system of claim 4, further comprising a threshold risk evaluation of said predetermined status, wherein said predetermined status is released by said objective third party pursuant to said release authorization and wherein said predetermined status is evaluated by said server according to a threshold risk criteria and is evaluated independently from said comparison of said calculated risk score to said risk tolerance criteria.

6. The system of claim 5 wherein said threshold risk evaluation is an automated FMS debt check performed by said server, wherein said server stores said authenticated record in said database with relationship to said one of said authorized user agents, wherein said networked communication interface is further comprised of a computer communications network and a telephonic communications network, wherein said server further comprises an auto-dialer device and a text-to-speech/speech-to-text processor, wherein said auto-dialer device connects with a voice command interface to an FMS debt record center through said telephonic communications network and said text-to-speech/speech-to-text processor converts textual information associated with said release authorization in said authenticated record into a synthesized voice, wherein said text-to-speech/speech-to-text processor communicates said synthesized voice to said voice command interface, wherein said auto-dialer device receives an FMS debt report from said FMS debt record center, wherein said FMS debt report is at least one of an oral report and an alpha-numeric data report received respectively through at least one of said telephonic communications network and said computer communications network, wherein said server stores said FMS debt report in relationship to said authenticated record, wherein said text-to-speech/speech-to-text processor converts said oral report to an alpha-numerical data report, and wherein said server parses said report to determine at least one of a presence of FMS debt and an absence of FMS debt, wherein said presence of FMS debt fails said threshold risk criteria and wherein said absence of FMS debt passes said threshold risk criteria.

7. The system of claim 5 wherein said server authorizes a payment to said right-holder when said predetermined status satisfies said threshold risk criteria and wherein said payment corresponds with said calculated risk score as compared with said risk tolerance criteria.

8. The system of claim 7 wherein said computer processor is provided by a client computer in networked communication with said server and with said database through said networked communication interface, wherein said client computer further comprises a display, a storage memory and a recording device, wherein said computer processor associates an electronic signature with said offer-to-sell and with said release authorization for a right-holder corresponding with said right-holder account to create said authenticated record, wherein said computer processor activates said recording device during a time period when said electronic documents are shown on said display and while said right-holder vocalizes at least a portion of said offer-to-sell and authenticates said release authorization and said offer-to-sell with said electronic signature, wherein said recording device produces a digital recording of said right-holder corresponding with said time period, wherein said computer processor saves said digital recording to said storage memory, wherein said computer processor sends said authenticated record to said server during a first time period and sends said digital recording to said server during a second time period after said first time period, wherein said computer processor instructs said server to associate said authenticated record and said digital recording to said right-holder account and a user agent account corresponding with said one of said authorized user agents.

9. The system of claim 7, further comprising a client computer comprising a client processor, a display, a storage memory and a recording device, wherein said computer processor is provided by said server, wherein said client processor is in networked communication with said computer processor and with said database through said networked communication interface, wherein said client processor receives from said server said offer-to-sell said portion of said future payment amount, said proposed sell price and said release authorization, wherein said client processor produces an executed record comprising an electronic signature associated with said offer-to-sell and associated with said release authorization for a right-holder corresponding with said right-holder account, wherein said client processor communicates said executed record to said computer processor, wherein said computer processor creates said authenticated record with an association of said executed record with said right-holder account and with a user agent account corresponding with said one of said authorized user agents, wherein said client processor activates said recording device during a time period when said electronic documents are shown on said display and while said right-holder vocalizes at least a portion of said offer-to-sell and authenticates said release authorization and said offer-to-sell with said electronic signature, wherein said recording device produces a digital recording of said right-holder corresponding with said time period, wherein said client processor saves said digital recording to said storage memory, wherein said client processor sends said executed record to said server during a first time period and sends said digital recording to said server during a second time period after said first time period.

10. The system of claim 5 wherein said purchase option factors are further comprised of a plurality of discount rates, wherein said offer-to-sell is comprised of at least a high offer, a medium offer and a low offer according to a selection of said discount rates, wherein said server identifies at least one acceptable offer from said offer-to-sell based on said calculated risk score.

11. The system of claim 5, further comprising a fraud check based on a comparison of historical information in said database with at least one of said right-holder information, said authenticated record and a plurality of authenticated records submitted by said one of said authorized agents, and wherein said future payment is at least one of a tax refund, a legal settlement and a life insurance payout.

12. A system for automatically evaluating an anticipated tax refund for purchase based on a tax return for a taxpayer, comprising:
a database comprising information on a plurality of authorized return originators and corresponding return originator accounts and respective sets of information on a plurality of taxpayer accounts, wherein said database further comprises at least one master rate table having a plurality of purchase option factors and at least one risk table having a plurality of risk factors;
an electronic document repository comprising at least one offer-to-sell template and at least one release authorization template;
a computer processor receiving from one of said authorized return originators a set of demographic information and a corresponding set of tax return information on a taxpayer account, wherein said tax return information includes at least one refund amount, wherein said computer processor receives at least one purchase option factor from said master rate table and uses said purchase option factor to determine a proposed sell price for at least a portion of said refund amount to be offered for sale, wherein said computer processor populates said offer-to-sell template with said proposed sell price, said refund portion offered for sale, and said demographic information, wherein said computer processor populates said release authorization template with said demographic information and wherein said computer processor associates an electronic signature with said populated offer-to-sell template and said populated release authorization template to form authenticated records, said electronic signature uniquely identifying the taxpayer corresponding with said taxpayer account;
a server providing a networked communication interface, wherein said authorized return originators access said return originator accounts in said database through said networked communication interface, wherein said server receives from said computer processor said tax return information, said proposed sell price, said refund portion offered for sale, and said electronic signature for said offer-to-sell template and said release authorization template, wherein said server determines a risk associated with paying said proposed sell price for said refund portion, and wherein said server compares said risk with a risk tolerance criteria retrieved from said risk factors in said database.

13. The system of claim 12, further comprising at least one funding account with an available funds balance, wherein a first set of said purchase option factors is comprised of at least one refund portion factor and a second set of purchase option factors is comprised of a plurality of discount rate factors, wherein said computer processor uses said refund portion factor to determine a maximum refund portion for said refund portion offered for sale and uses a first discount rate to determine said proposed sell price, wherein said server confirms said available funds balance satisfies a funding requirement greater than said proposed sell price, wherein said server receives an approved return report from said computer processor, wherein said server authorizes a payment for said proposed sell price when said funding requirement is satisfied, when said risk is within said risk factors and after receiving said approved return report.

14. The system of claim 13 wherein said risk is comprised of a threshold risk and a calculated risk score, wherein said risk factors are further comprised of a threshold risk criteria and said risk tolerance criteria, wherein said threshold risk is comprised of a predetermined FMS debt status determined independently from said calculated risk score and is compared to said threshold risk criteria, wherein said predetermined FMS debt status is obtained from FMS information released pursuant to said release authorization template and said electronic signature, wherein said calculated risk score is based on said tax return information, said proposed sell price and said maximum refund portion.

15. The system of claim 14 wherein said proposed sell price is further comprised of a maximum proposed sell price, an intermediate proposed sell price and a minimum proposed sell price, wherein said refund portion offered for sale is respectively comprised of said maximum refund portion, an intermediate refund portion and a minimum refund portion, wherein said first set of said purchase option factors is comprised a maximum refund portion factor, an intermediate refund portion factor and a minimum refund portion factor, wherein said computer processor respectively determines said maximum refund portion, said intermediate refund portion and said minimum refund portion using said maximum refund portion factor, said intermediate refund portion factor and said minimum refund portion factor, and wherein said computer processor applies said discount rate factors to respectively calculate said maximum proposed sell price, said intermediate proposed sell price and said minimum proposed sell price for optional offers of said maximum refund portion, said intermediate refund portion and said minimum refund portion, and wherein said server identifies at least one acceptable offer from said optional offers according to said calculated risk score.

16. The system of claim 14 wherein said calculated risk score is further comprised of a taxpayer risk score, a funding risk score, and a return originator risk score, wherein said taxpayer risk score is based on said tax return information, said proposed sell price and said maximum refund portion, wherein said funding risk score is based on said available funds balance, an amount of funds already spent during a tax season time period, a remaining time in said tax season time period and historical weighting factors corresponding with said remaining time, wherein said return originator risk score is based on a comparison of historical information in said database, an anticipated return rate, and an actual return rate, wherein said predetermined FMS debt status is determined from an automated FMS debt check, wherein said networked communication interface is further comprised of a computer communications network and a telephonic communications network, wherein said server further comprises an auto-dialer device and a text-to-speech/speech-to-text processor, wherein said auto-dialer device connects with a voice command interface to an FMS debt record center through said telephonic communications network and said text-to-speech/speech-to-text processor converts textual information associated with said release authorization template into a synthesized voice, wherein said text-to-speech/speech-to-text processor communicates said synthesized voice to said voice command interface, wherein said auto-dialer device receives an FMS debt report from said FMS debt record center, wherein said FMS debt report is at least one of an oral report and an alpha-numeric data report received respectively through at least one of said telephonic communications network and said computer communications network, wherein said server stores said FMS debt report in relationship to said authenticated record, wherein said text-to-speech/speech-to-text processor converts said oral report to an alpha-numerical data report, and wherein said server parses said report to determine said FMS debt status comprised of at least one of a presence of FMS debt and an absence of FMS debt, wherein said presence of FMS debt fails said threshold risk criteria and wherein said absence of FMS debt passes said threshold risk criteria.

17. The system of claim 12 wherein said computer processor is provided by a client computer in networked communication with said server and with said database through said networked communication interface, wherein said client computer further comprises a display, a storage memory and a recording device, wherein said computer processor activates said recording device during a live time period when said populated offer-to-sell template and said populated release authorization are shown on said display while the taxpayer identified by said electronic signature vocalizes at least a portion of said authenticated records, wherein said recording device produces a digital recording of the taxpayer during said live time period, wherein said processor saves said digital recording to said storage memory in association with said electronic signature and said corresponding authenticated records, wherein said client computer sends said authenticated records to said server during a first time period after said live time period and sends said digital recording to said server during a second time period after said first time period.

18. A system for automatically evaluating an anticipated tax refund for purchase based on a tax return for a taxpayer, comprising:
a database comprising information on a plurality of authorized return originators and corresponding return originator accounts and respective sets of information on a plurality of taxpayer accounts, wherein said database further comprises at least one master rate table having a plurality of purchase option factors and a risk table having a plurality of risk factors, said risk factors comprising a threshold risk criteria and a plurality of risk tolerance criteria, wherein a first set of purchase option factors is comprised of at least one refund portion factor and a second set of purchase option factors is comprised of a plurality of discount rate factors;
an electronic document repository comprising at least one offer-to-sell template and at least one release authorization template;
a computer comprising a display, a processor, a storage memory and a recording device, wherein said processor receives from one of said authorized return originators a set of demographic information and a corresponding set of tax return information on a taxpayer account, wherein said tax return information includes at least one anticipated refund amount, an income amount and information on claimed dependents, wherein said processor receives said refund portion factor and at least one discount rate factor from said master rate table and uses said refund portion factor and said discount rate to determine a range of refund portions of said anticipated refund amount to be offered for sale and a range of sell prices for said corresponding range of refund portions respectively, wherein said processor populates said offer-to-sell template with said range of sell prices, said corresponding range of refund portions, and said demographic information, wherein said processor populates said release authorization template with said demographic information, wherein said processor creates a digital signature uniquely identifying the taxpayer associated with said taxpayer account, said digital signature comprising an electronic signature and an authentication from a digital certificate, wherein said processor produces authenticated records comprising said digital signature associated with said populated offer-to-sell template and associated with said populated release authorization template, wherein said processor activates said recording device during a live time period when said populated offer-to-sell template and said populated release authorization are shown on said display and while the taxpayer reads at least a portion of said authenticated records, wherein said recording device produces a digital recording of the taxpayer during said live time period, and wherein said processor saves said digital recording to said storage memory;
a server providing a networked communication interface, wherein said authorized return originators access said return originator accounts in said database through said networked communication interface, wherein said server receives from said processor said tax return information, said range of sell prices, said range of corresponding refund portions, and said digital signature for said authenticated records, wherein said server coordinates a threshold risk evaluation based on an FMS debt check and said threshold risk criteria, wherein said server determines a set of calculated risk scores associated with paying said range of sell prices for said corresponding range of refund portions, wherein said server compares said set of calculated risk scores with said risk tolerance criteria, wherein said server identifies at least one acceptable offer having a sell price in said range of said sell prices based on said set of calculated risk scores, wherein said server receives an approved tax return report for the tax return, wherein said server authorizes a payment corresponding with said acceptable offer to the taxpayer when both a predetermined FMS debt status satisfies said threshold risk criteria and at least one calculated risk score in said set of calculated risk scores is within an allowable risk level in said risk tolerance criteria and after receiving said approved return report, and wherein said predetermined FMS debt status is a threshold risk determined independently from said set of calculated risk scores and is obtained pursuant to a release authorization obtained from said authorized records.

19. The system of claim 18 further comprising at least one funding account with an available funds balance, wherein said server receives a plurality of authenticated records from said plurality of authorized return originators for said plurality of taxpayer accounts, wherein said server prioritizes a first set of said authenticated records in which said predetermined FMS debt status satisfies said threshold risk criteria over a second set of said authenticated records in which said predetermined FMS debt status fails said threshold risk criteria, wherein said server prioritizes a plurality of allocations from said available funds balance to said first set of authenticated records according to a ranking of said calculated risk scores for said authenticated records, wherein said server selects said sell price from said range of sell prices according to said ranking of said calculated risk scores.

20. The system of claim 18 wherein each of said calculated risk scores is comprised of a taxpayer risk score, a funding risk score, and a return originator risk score, wherein said taxpayer risk score is based on tax return information, said proposed sell price and said range of refund portions, said funding risk score including a first weighting for W-2 income and a second weighting for Schedule C income in said tax return information, wherein said funding risk score is based on said available funds balance, an amount of funds already spent during a tax season time period, a remaining time in said tax season time period and historical weighting factors corresponding with said remaining time, wherein said return originator risk score is based on a comparison of historical information in said database, an anticipated return rate, and an actual return rate, wherein said server calculates a return accuracy factor based on a comparison of an actual refund amount with said anticipated refund amount for each of said authenticated records in which said payment was made and correlates a statistical relationship between said return accuracy factor and said income amount in said tax return information.
